(19) United States
(12) Patent Application Publication
(10) Pub. No.: US 2019/0005420 A1
(43) Pub. Date: Jan. 3, 2019

(54) MANAGEMENT SUPPORT DEVICE, MANAGEMENT SUPPORT METHOD, AND RECORDING MEDIUM STORING A PROGRAM

(71) Applicant: SEIKO EPSON CORPORATION, Tokyo (JP)

(72) Inventors: Tadasuke FUJIMOTO, Matsumoto-shi (JP); Tetsuya MATSUZAWA, Minowa-machi (JP); Masashi KITAMURA, Shimosuwa-cho (JP); Kazuaki MURATA, Azumino-shi (JP)

(21) Appl. No.: 16/016,887

(22) Filed: Jun. 25, 2018

(30) Foreign Application Priority Data
Jun. 28, 2017 (JP) 2017-125926

(51) Int. Cl. G06Q 10/06; G06Q 40/00; G06F 17/30

(52) U.S. Cl. CPC G06Q 10/063; G06F 17/30076; G06F 17/30312; G06Q 40/125

(57) ABSTRACT

Provided are a management support device, a management support method, and a program for calculating managerial index values based on financial data and outputting multiple analytical results. A management support device 10 includes: a data acquisition device 30 that acquires financial data to analyze; a business analyzer 32 configured to calculate managerial index values based on the acquired financial data, and based on a database 23 relating managerial index values and analytical results, and the calculated managerial index values, analyze the target business operation; an output device 28 that outputs the analytical results from the analytical function 32. The database 23 stores multiple relations of managerial index values and analytical results. The analytical function 32 determines the multiple analytical results corresponding to the calculated managerial index values. The web control function 28 outputs the multiple calculated analytical results.

### BACKGROUND

### 1. Technical Field

The present invention relates to a management support device, a management support method, and a recording medium storing a program.

### 2. Related Art

JP-A-2014-229219 describes a management support system as an example of a system that acquires sales information indicating sales and the cost of sales, for example, performing a business analysis based on the acquired sales information, and providing the result of the business analysis to the user.

This management support system acquires sales information sent monthly from individual shops on a server. The management support system then executes the business analysis based on the acquired sales information, repeatedly queries the user about sales target trends (such as sales, ratio of profit to sales, marginal income), and looks for a management improvement plan based on the answers to the questions.

However, because the type of response desired in the result of the business analysis differs for many reasons, including the knowledge level and preferences of the user, a business analysis as described in JP-A-2014-229219 may not provide the kind of result desired by the user.

### SUMMARY

The present invention is directed to solving at least part of the foregoing problem, and can be embodied as described in the embodiments and examples described below.

### Example 1

A management support device according to this aspect of the invention has a data acquisition device configured to acquire financial data to process; a business analyzer configured to calculate a managerial index value based on the acquired financial data, and based on a database relationally storing managerial index values and analytical results, analyze operations of a target business; and an output device configured to output the analytical result from the business analyzer. The database stores multiple instances of managerial index value and analytical result relations. The business analyzer determines multiple analytical results corresponding to the calculated managerial index values, and the output device outputs the multiple analytical results identified by the business analyzer.

This configuration enables calculating managerial index values based on financial data, referencing a database storing multiple instances of managerial index value and analytical result relations, and outputting multiple analytical results. Because multiple analytical results pertinent to a particular business situation can be output, the user can more easily acquire the desired analytical results and user convenience is excellent.

### Example 2

Preferably, the management support device also has an input device configured to receive input of a selection command from a user; and when a selection command selecting an analytical result from among the multiple output analytical results is received from the input device, the output device outputs only the selected analytical result as the analytical result.

With this configuration the user can more easily acquire the desired analytical results and user convenience is excellent.

### Example 3

Further preferably in the management support device described above, the output device outputs the multiple analytical results in a first format, and outputs the selected analytical result in a second format that is more detailed than the first format.

This configuration enables reducing the size of the display area for outputting analytical results in a simple format when displaying multiple analytical results. More information can also be displayed on devices with a small display, such as smartphones.

### Example 4

Further preferably in the management support device described above, the business analyzer, based on the calculated managerial index values and the financial data, generates interpretive result data including the analytical results and a graph corresponding to the analytical results; and the output device outputs the interpretive result data.

This configuration automatically generates a graph once the analytical result to be described are selected. The task of generating a graph is also simplified.

### Example 5

Further preferably in the management support device described above, when the input device receives a range command from the user specifying a focus range for a graph of the interpretive result data, the business analyzer determines the analytical results corresponding to the range specified by the range command.

This configuration enables acquiring the desired analytical results by selecting what the graph should focus on. The interpretive result data can also be produced more efficiently. Furthermore, by using a display with touch panel functionality, data can be analyzed in real time to acquire the desired analytical result comments.

### Example 6

Further preferably in the management support device described above, the business analyzer, based on the financial data and the range command, calculates the managerial index values corresponding to the range specified by the range command, references the database, and determines the analytical result corresponding to the calculated values of the corresponding managerial index.

By selecting what the graph should focus on, this configuration acquiring the desired analytical results by referencing a database storing multiple relations between managerial index values and analytical results.

### Example 7

Further preferably in the management support device described above, the database stores, for each analytical result, text data including a structured string corresponding to the analytical result, and an insertion field to which the value of the managerial index corresponding to the text string is inserted; and the business analyzer determines the analytical result by inserting the calculated value of the managerial index to the input field of the text data corresponding to the analytical result.

This aspect of the invention can efficiently construct a story describing a management improvement plan automatically in response to the user selecting an analytical result comment. In addition, stories can be created more efficiently than when stories are created freely.

### Example 8

Further preferably in the management support device described above, the business analyzer determines an importance level for each analytical result; and the output device outputs multiple analytical results in an order based on the importance level.

Because the analytical results are output in order of importance, this aspect of the invention enables getting results in less time. Furthermore, because the analytical results are presented in the order of importance, there is less chance of the most valuable results being discarded or overlooked.

### Example 9

Further preferably in the management support device described above, the output device outputs the multiple determined analytical results as a file in a specific format.

This aspect of the invention improves ease of use for the user. For example, if the user is a consultant providing advice related to business management, the user can open the file output from the management support device, add information and edits to the analytical results as desired, and provide more appropriate advice to the business.

### Example 10

Another aspect of the invention is a management support method of a management support device including: a data acquisition step of acquiring financial data to process; a business analysis step of calculating managerial index values based on the acquired financial data, and analyzing operations of a target business based on the calculated managerial index values and a database of managerial index value and analytical result relations; and an output step of outputting the analytical results of the business analysis step. The database stores multiple instances of managerial index value and analytical result relations. The business analysis step determines multiple analytical results corresponding to the calculated managerial index values, and the output step outputs the multiple analytical results from the business analysis step.

This configuration enables calculating managerial index values based on financial data, referencing a database storing multiple instances of managerial index value and analytical result relations, and outputting multiple analytical results. Because multiple analytical results pertinent to a particular business situation can be output, the user can more easily acquire the desired analytical results and user convenience is excellent.

### Example 11

Another aspect of the invention is a program that causes a computer to execute a data acquisition function of acquiring financial data to process; a business analysis function of calculating managerial index values based on the acquired financial data, and analyzing operations of a target business based on the calculated managerial index values and a database of managerial index value and analytical result relations; and an output function of outputting the analytical results of the business analysis function. The database stores multiple instances of managerial index value and analytical result relations. The business analysis function determines multiple analytical results corresponding to the calculated managerial index values, and the output function outputs the multiple analytical results from the business analysis function.

This configuration enables calculating managerial index values based on financial data, referencing a database storing multiple instances of managerial index value and analytical result relations, and outputting multiple analytical results. Because multiple analytical results pertinent to a particular business situation can be output, the user can more easily acquire the desired analytical results and user convenience is excellent.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 schematically illustrates the configuration of a management support system according to a preferred embodiment of the invention.

FIG. 2 illustrates the configuration of a management support server according to a preferred embodiment of the invention.

FIG. 3 is a flow chart of the operation of a management support system according to a preferred embodiment of the invention.

FIG. 4 is a flow chart of the operation of a management support system according to a preferred embodiment of the invention.

FIG. 5 shows a first example of a display screen according to a preferred embodiment of the invention.

FIG. 6 shows an example of an analytical result candidate selection area according to a preferred embodiment of the invention.

FIG. 7 shows a second example of a display screen according to a preferred embodiment of the invention.

FIG. 8 shows a third example of a display screen according to a preferred embodiment of the invention.

FIG. 9 shows a fourth example of a display screen according to a preferred embodiment of the invention.

FIG. 10 shows an example of the data structure of a comment information database according to a preferred embodiment of the invention.

FIG. 11 shows an example of the perspective of an embodiment of the invention and analytical result comments.

FIG. 12 is a flow chart of the operation of a management support system according to a first variation of the invention.

FIG. 13 shows an example of the data structure of a comment information database according to a second variation of the invention.

### DESCRIPTION OF EMBODIMENTS

Preferred embodiments of the invention are described below with reference to the accompanying figures. Note that the accompanying figures are suitable enlarged or reduced to facilitate recognition of aspects described below.

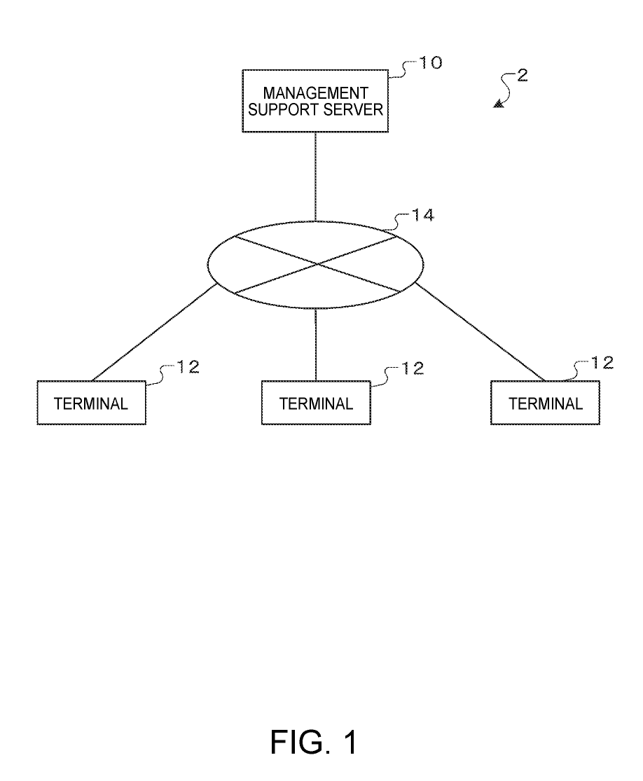

FIG. 1 schematically illustrates the configuration of a management support system according to a preferred embodiment of the invention.

As shown in FIG. 1, a management support system 2 according to this embodiment of the invention is configured with a management support server 10 as an example of a management support device, and a terminal 12, connected over the Internet 14. In this embodiment of the invention the management support server 10 corresponds to a group of devices including a server device and database devices, but may obviously be configured as a single server device incorporating the functions of a server device and database devices.

The management support system 2 causes the management support server 10 to run a business analysis process based on the financial data (such as the numeric information from the balance sheets, numeric information from the profit and loss statements, or numeric information from the cash flow statements, covering a multiyear period) of a specific business, and provides the results of the business analysis to a terminal 12 through a business accounting website provided by the management support server 10.

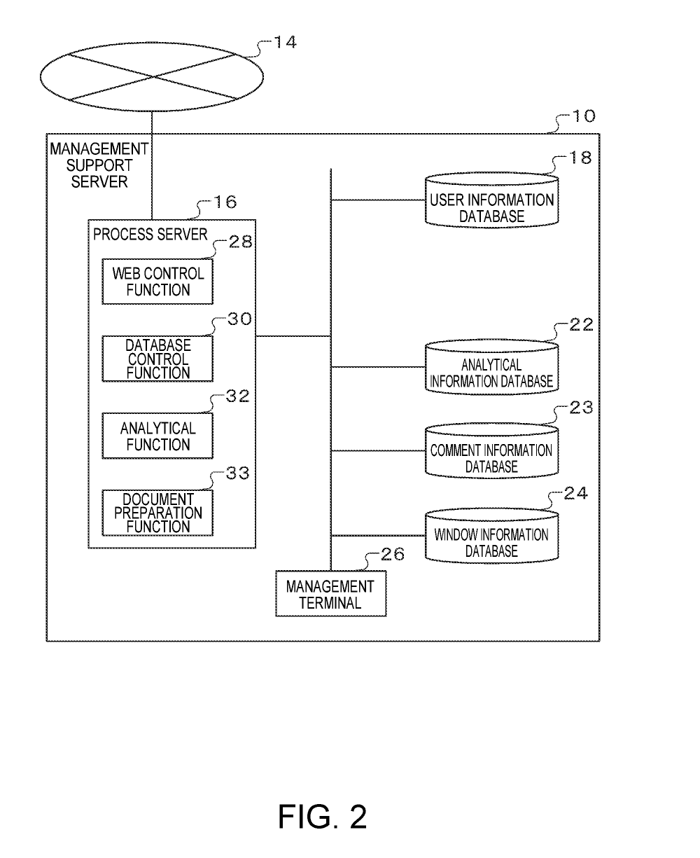

FIG. 2 illustrates the configuration of a management support server 10 according to this embodiment.

The management support server 10 is a management support device for providing a business accounting website, and as shown in FIG. 2 includes a process server 16, a user information database 18, an analytical information database 22, a comment information database 23, a window information database 24, and a management terminal 26.

The process server 16 of the management support server 10 includes a CPU (central processing unit), ROM (read-only memory), and RAM (random access memory), all not shown.

The process server 16 has a database control function 30 as a data acquisition device configured to embody the function of a database server; an analytical function 32 as a business analyzer that determines trends in indices of business analysis; a document preparation function 33 that produces business analysis documents; and a web control function 28 as an input/output device that provides a business accounting website by functioning as a world-wide web server.

These functions of the process server 16 are embodied by, for example, a CPU executing programs stored in RAM. Some or all of these functions may be embodied by hardware devices such as LSI (Large Scale Integration) or ASIC (Application Specific Integrated Circuit) devices, or by the cooperation of a CPU and other hardware devices.

The database control function 30 acquires financial data to be analyzed for a specific business from a financial database not shown. Alternatively, financial data may be acquired from the terminal 12 by the user inputting financial data to the terminal 12. The acquired financial data is then registered in the analytical information database 22.

The analytical function 32 analyzes operations of the target business. The analytical function 32 calculates managerial indices based on the acquired financial data. The analytical function 32 calculates multiple managerial indices related to the business operation based on the acquired financial data. Note that the values of the managerial indices are not limited to a single value, and may include a range of values.

The analytical function 32 references the comment information database 23, and for multiple combinations of values about multiple managerial indices and analytical result comments (analytical results), determines whether or not those combinations correlate to a business situation. Based on the comment information database 23, the analytical function 32 determines the appropriate analytical result comment for the calculated values of the managerial indices. Based on the comment information database 23 relating managerial index values to analytical result comments, the analytical function 32 determines the analytical result comment corresponding to the calculated value of the managerial index.

The analytical function 32 determines the analytical result comment corresponding to the plural managerial index values that were calculated by referencing the comment information database 23. By referencing the comment information database 23 storing multiple combinations of multiple managerial index values and analytical result comments, the analytical function 32 determines the one or multiple analytical result comments that correspond to the multiple calculated managerial index values. Note that the comment information database 23 has multiple combinations of multiple managerial index values and structured text (boilerplate) data (comments) expressing the analytical result (see FIG. 10).

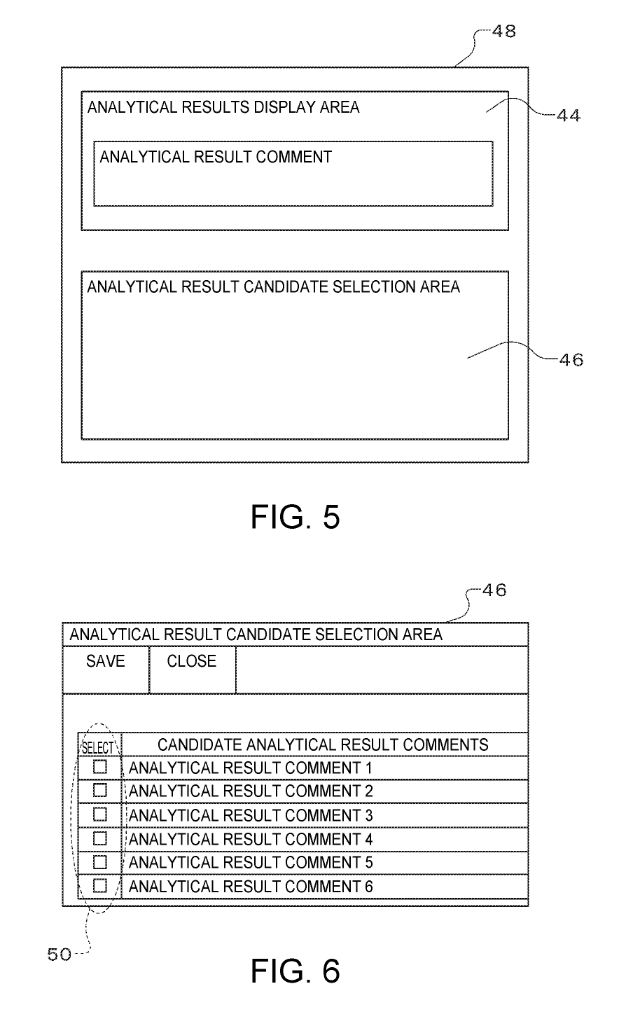

When generating multiple analytical result comments, the analytical function 32 determines the analytical result comments in a simple display format. When determining the analytical result comment selected by the user from among the analytical result comments in a simple display format, the analytical function 32 determines the analytical result comment in a detailed display format. As a result, the size of the analytical result candidate selection area 46 (FIG. 5) for outputting analytical result comments in a simple display format related to multiple analytical result comments can be reduced. In addition, much information can be displayed even on devices with a small display, such as smartphones.

The analytical function 32 determines an importance level 74 (see FIG. 10) for each analytical result comment. The analytical function 32 determines multiple analytical result comments in order based on the importance level 74.

The web control function 28 outputs the multiple analytical result comments in order based on the importance level 74. Because the analytical result comments can thus be output in order based on the value of the importance level 74, results can be acquired in a short time. Because the analytical result comment can be seen in order based on the value of the importance level 74, there is less chance of the most valuable result being discarded. The analytical function 32 references the importance level 74 for each analytical result comment. The analytical function 32 also sorts the multiple analytical result comments in order based on the referenced importance level 74. The analytical function 32 also determines multiple analytical result comments in order based on the importance level 74.

Based on the calculated value of the managerial index or the financial data, the analytical function 32 also generates interpretive result data including the analytical result comments and a graph corresponding to the analytical result comments. The web control function 28 outputs the interpretive result data. The interpretive result data includes the analytical result comments and a graph corresponding to the analytical result comments. As a result, once the analytical result comments to explain are determined, a graph is also automatically generated. The task of generating a graph is also simplified.

The web control function 28 outputs the analytical result comment from the analytical function 32. The web control function 28 outputs the selected analytical result comments. When the analytical function 32 produces multiple analytical result comments corresponding to the calculated managerial index values, the web control function 28 outputs multiple analytical result comments. The web control function 28 outputs multiple analytical result comments. The web control function 28 also outputs the interpretive result data including the analytical result comments and graphs corresponding to the analytical result comments.

The web control function 28 receives user input of selection commands. When an operating command to select an analytical result comment from among the plural analytical result comments that are output is input, the web control function 28 outputs only the selected analytical result comments as the analytical result comments. As a result, the user can more easily acquire the desired analytical result comments, and user convenience is further improved.

The web control function 28 outputs the analytical result comments in a simple display format in the analytical result candidate selection area 46 (see FIG. 5). The web control function 28 also outputs the analytical result comments in a detailed display format to the analytical results display area 44 (see FIG. 5). When an analytical result comment is selected in the analytical result candidate selection area 46, the web control function 28 displays the text of the analytical result comment in a detailed display format in the analytical results display area 44.

The web control function 28 outputs the selected analytical result comment in an area adjacent to where the graph is displayed. The related art requires determining where to show the analytical result comment based on the relationship between the graph and analytical result comments. This embodiment of the invention eliminates this step.

When displaying multiple analytical result comments, the web control function 28 outputs the analytical result comments in a simple format (first format). When displaying a particular analytical result comment selected by the user, the web control function 28 outputs the analytical result comment in a more detailed format (second format) than the simple format. As a result, when displaying multiple analytical result comments, the size of the analytical result candidate selection area 46 (see FIG. 5) in which analytical result comments are output in a simple format can be reduced. In addition, much information can be displayed even on devices with a small display, such as smartphones.

Note that the process server 16 does not need to be configured by a single physical computer, and may be configured from multiple computers.

The database control function 30 is an example of a data acquisition device in the accompanying claims.

The analytical function 32 is an example of a business analyzer in the accompanying claims.

The web control function 28 is an example of an output device and an input device in the accompanying claims.

The comment information database 23 is an example of a database in the accompanying claims.

Note also that the input device (web control function 28) receives (input) of operating commands from a terminal 12 operated by the user, and when the management support device is a terminal 12, operating commands may be input to the terminal 12 by a user operation.

The output device in this example displays information on a display screen of the management support system on the terminal 12 side, but may be configured to send a file containing the analytical result comments to the terminal 12.

The process server 16 executes a process authenticating access attempts from a terminal 12 through the Internet 14, extracts information from the databases 18 to 24, dynamically generates a business accounting website, and presents the website to the authenticated terminal 12.

The user information database 18 stores, for registered users permitted to access the process server 16, information such as the user ID, password, business name, manager name, department name, and contact information (such as the address, telephone number, fax number, and e-mail address).

Note that the user ID is an identifier the administrator of the management support server 10 assigns to each user. The administrator uses the management terminal 26 to store the user ID in the user information database 18.

The password is authentication information required to access the process server 16. The administrator uses the management terminal 26 to store the password selected by the user in the user information database 18.

The process server 16 identifies the accessing party (business) based on the ID, and authenticates the accessing party based on the user ID and password.

The business name, manager name, department name, and contact information are also input by the user operating the terminal 12, and stored in the user information database 18.

The analytical information database 22 stores financial data used by the process server 16 for business analysis. The financial data is acquired by the database control function 30 as described above.

The comment information database 23 stores multiple combinations of values for multiple managerial indices and structured text data (comments) describing the analytical results (see FIG. 10). Note that the comment information database 23 includes structured text data for both simple format comments and detailed format comments.

The window information database 24 stores screen information used to generate the business accounting website provided by the process server 16. The screen information is stored to the window information database 24 based on input by the administrator operating the management terminal 26.

The terminal 12 shown in FIG. 1 is a device for sending information to the management support server 10, and is a device for displaying the business accounting website. The terminal 12 in this example is a personal computer or workstation.

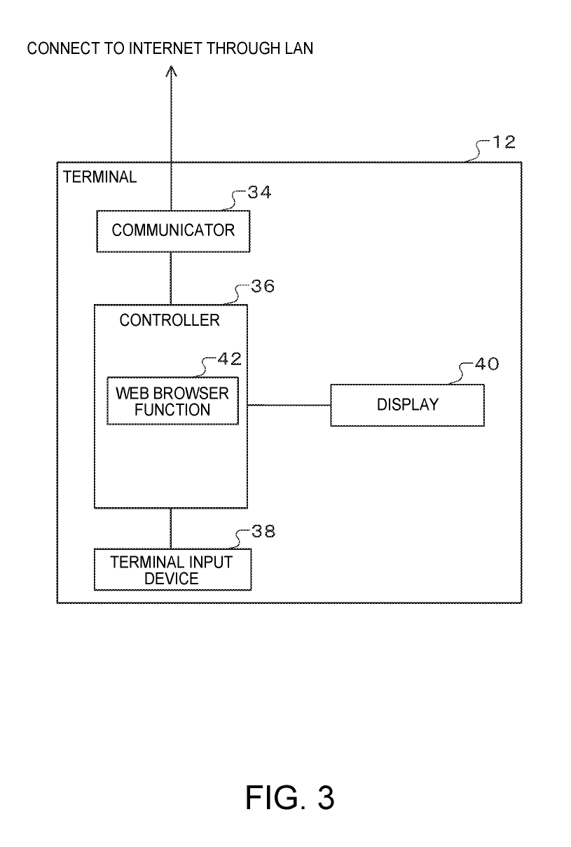

FIG. 3 illustrates the configuration of a terminal 12 in this embodiment of the invention. As shown in FIG. 3, the terminal 12 has a communicator 34, controller 36, terminal input device 38, and display 40.

The communicator 34 is an interface connected to a LAN (local area network) or other network. The communicator 34 communicates with the Internet 14 through the LAN.

The controller 36 controls the terminal 12. The controller 36 includes a CPU, ROM, and RAM not shown. The controller 36 also has a web browser function 42 embodied by installing a web browser. The user can view the business accounting website on the terminal 12 by starting the web browser function 42.

The terminal input device 38 in this example is a keyboard. The user, by operating the terminal input device 38, inputs the user ID and password to the login screen (not shown in the figure) of the business accounting website, and logs into the business accounting website.

The first time the user logs in, for example, the user operates the terminal input device 38 to input the business name, manager name, department name, and contact information. When input is completed, the controller 36 outputs information including the user ID and password added to the input information from the communicator 34 to the Internet 14. The information output to the Internet 14 is input to the management support server 10. The management support server 10 (database control function 30) stores the information received over the Internet 14 to the user information database 18.

The display 40 is an LCD displays in this example. The business accounting website, for example, is displayed on the display 40. Display areas on the display 40 include an analytical results display area 44 (see FIG. 5) and candidate analytical results selection area 46 (see FIG. 5). Displayed in the analytical result candidate selection area 46 are the analytical result comments resulting from analyzing the financial data. Displayed in the analytical results display area 44 is the analytical result comment selected from the analytical result candidate selection area 46.

Operation of the management support system 2 described above is described next.

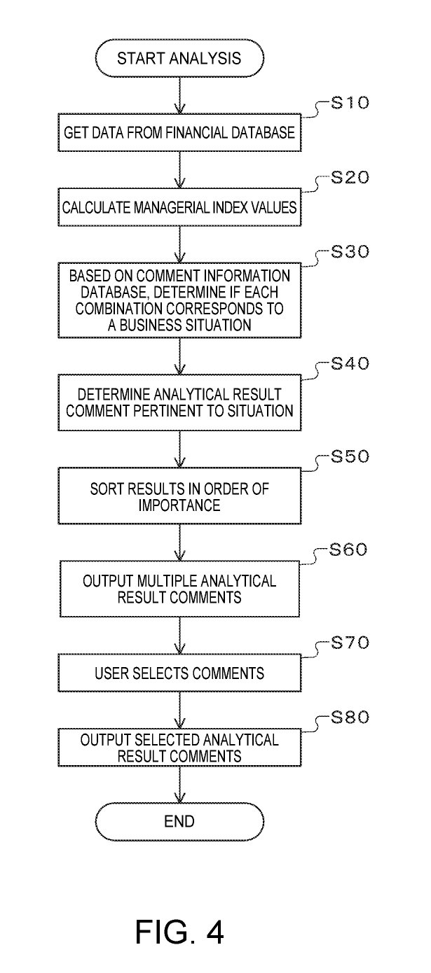

FIG. 4 is a flow chart of the operation of the management support system 2 according to this embodiment of the invention. The management support method according to this embodiment is the management support method executed by the management support server 10, and includes a data acquisition step, business analysis step, and output step.

The data acquisition step acquires financial data for the business for which the analysis is processed.

The business analysis step calculates the values of one or more managerial indices based on the acquired financial data. The business analysis step also determines the analytical result comments corresponding to the calculated values of the managerial indices based on the comment information database 23 relationally storing analytical result comments to managerial index values.

The output step outputs the generated analytical result comments.

The comment information database 23 stores multiple records relating managerial index values to analytical result comments. When the analysis of the business analysis step identifies multiple analytical result comments corresponding to a calculated managerial index value, the output step outputs multiple analytical result comments.

First, in step S10 (data acquisition step), the database control function 30 reads financial data for the target business from the financial data database into the analytical information database 22.

Next, in step S20 (business analysis step), the analytical function 32 calculates, based on the financial data read into the analytical information database 22, multiple managerial index values related to the operations of the target business.

Next, in step S30 (business analysis step), the analytical function 32 references the comment information database 23, and for multiple combinations of values about multiple managerial indices and analytical result comments, determines whether or not those combinations correlate to a business situation. The comment information database 23 stores multiple relations between managerial index values and analytical result comments.

Next, in step S40 (business analysis step), the analytical function 32, by referencing the comment information database 23 storing multiple combinations of values for multiple managerial indices and analytical result comments, identifies one or more analytical result comments corresponding to the multiple managerial index values that were calculated.

Next, in step S50 (business analysis step), the analytical function 32 references the importance level 74 (see FIG. 10) of each analytical result comment, and sorts the multiple analytical result comments in order based on the importance level 74.

Next, in step S60 (output step), the web control function 28 outputs the multiple analytical result comments to the candidate analytical results selection area 46 (see FIG. 5). When multiple analytical result comments are identified by the analysis of the analytical function 32 for a calculated managerial index value, the web control function 28 outputs the multiple analytical result comments to the analytical result candidate selection area 46. Note that when the number of identified analytical result comments is greater than a specific number, the web control function 28 may be configured to output only a specific number of analytical result comments sequentially from the analytical result comment with the highest importance level 74.

Next, in step S70, the web control function 28 receives from the terminal 12 the user selection of the analytical result comments desired from among the multiple analytical result comments shown in the analytical result candidate selection area 46 based on user operation of the terminal 12.

Next, in step S80, the analytical function 32 identifies the analytical result comments selected by the user from among the multiple analytical result comments. The web control function 28 then outputs the selected analytical result comments to the analytical results display area 44 (see FIG. 5).

### Business Analysis Step

FIG. 5 shows a first example of a screen configuration according to this embodiment.

When the user inputs a command from the terminal 12 to run a business analysis, the process server 16 reads screen information stored in the window information database 24 and the financial data stored in the analytical information database 22, and as shown in FIG. 5, generates a window 48 including a analytical results display area 44 and analytical result candidate selection area 46, for example. The process server 16 sends the generated window 48 to the terminal 12. As a result, the terminal 12 displays the window 48 on the display 40. The web control function 28 provides a window 48 including the analytical results display area 44 and analytical result candidate selection area 46 to the user.

FIG. 6 shows an example of a analytical result candidate selection area 46 according to this embodiment. As shown in FIG. 6, the process server 16 displays the multiple simple format analytical result comments calculated by the analytical function 32 in the analytical result candidate selection area 46.

The process server 16 prompts the user to select the required analytical result comments from among the analytical result comments shown in the analytical result candidate selection area 46 by the selection buttons 50. The process server 16 then displays the comments in a detailed format for the analytical results selected by the user in the analytical results display area 44. If the user checks the analytical result comment displayed in the analytical results display area 44 and does not find a problem, the process server 16 passes the analytical result comment displayed in the analytical results display area 44 to the document preparation function 33, and creates a business analysis document.

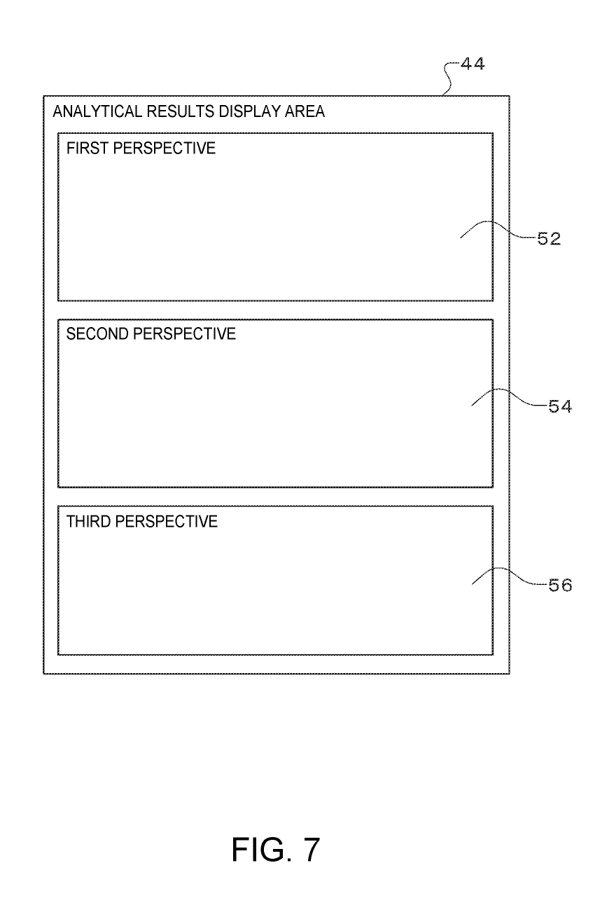

FIG. 7 shows a second example of a screen configuration according to this embodiment. This analytical results display area 44 has display areas for different perspectives (in this example, first perspective 52, second perspective 54, third perspective 56). Note that a perspective as used herein denotes a business index to watch, such as sales, expenses, and profits. The analytical result comments calculated for the perspectives selected in the analytical result candidate selection area 46 are displayed in the analytical results display area 44. When an analytical result comment is selected in the analytical result candidate selection area 46, the selected analytical result comment is displayed in the corresponding perspective pane of the analytical results display area 44. The analytical result comments are displayed in the analytical results display area 44 grouped by perspective. By selecting analytical result comments of different perspectives in the analytical result candidate selection area 46, a story describing a management improvement plan can be constructed.

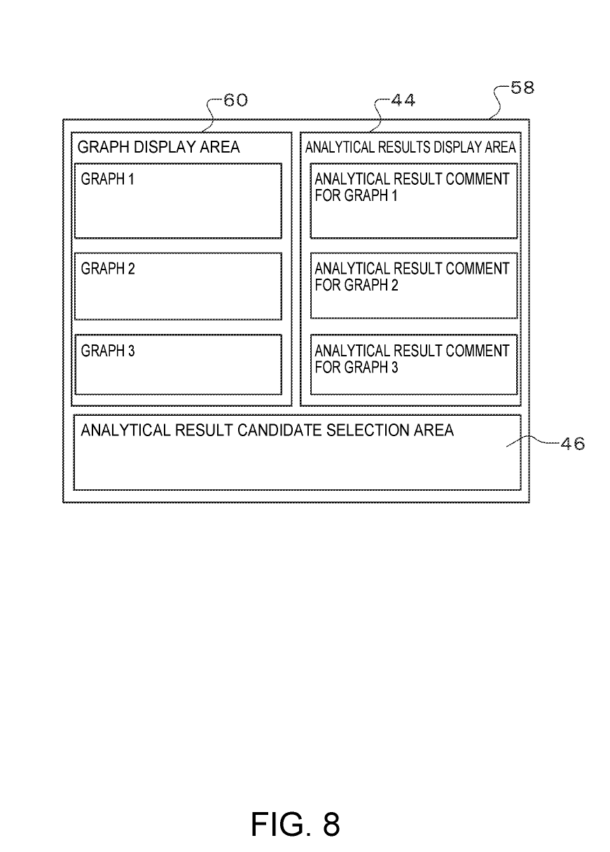

FIG. 8 shows a third example of a screen configuration according to this embodiment.

Window 58 has a graph display area 60 for displaying graphs corresponding to analytical result comments, an analytical results display area 44, and an analytical result candidate selection area 46. The analytical results display area has display areas for displaying the analytical result comments corresponding to the graphs shown in the graph display area 60. When the user selects a desired analytical result comment in the analytical result candidate selection area 46, the analytical function 32 creates a graph corresponding to the analytical result comment based on the financial data, and the web control function 28 displays the analytical result comment in the display area of the analytical results display area 44 corresponding to the graph.

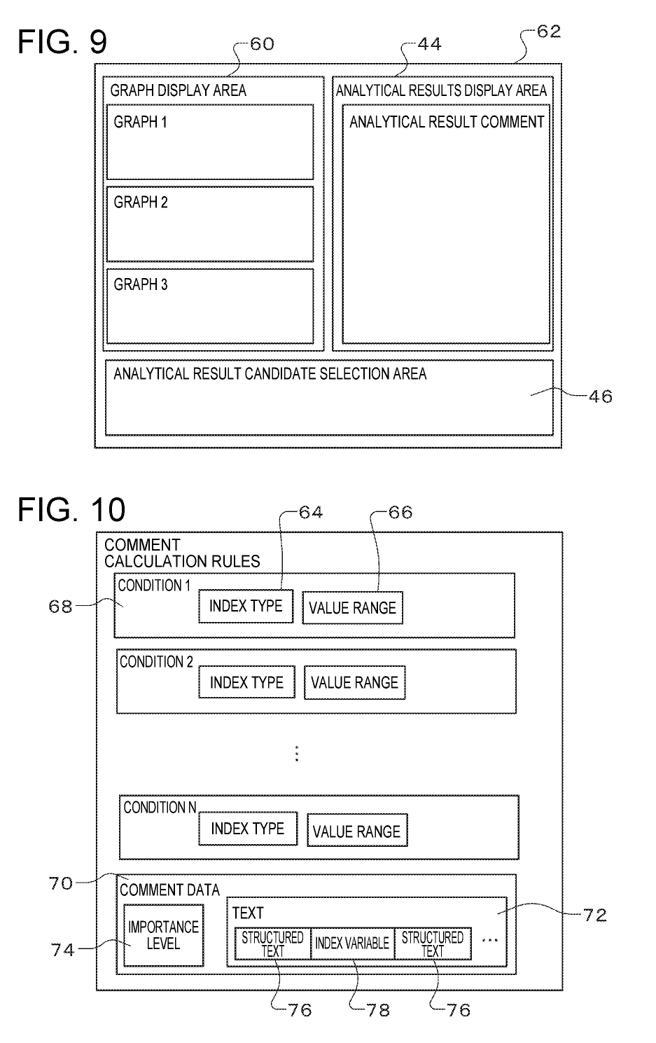

FIG. 9 shows a fourth example of a screen configuration according to this embodiment.

Window 62 in this example has a graph display area 60 for displaying graphs corresponding to analytical result comments, an analytical results display area 44, and an analytical result candidate selection area 46. When a desired analytical result comment is selected in the analytical result candidate selection area 46, the analytical function 32 creates a graph corresponding to the analytical result comment, and the web control function 28 displays the graph in the graph display area 60.

The web control function 28 in this example displays analytical result comments with a set of managerial index graphs. The analytical function 32 determines the graphs to display according to the analytical result comments selected by the user. As a result, the graphs are generated automatically when an analytical result comment is selected. This process also eliminates the job of creating graphs as a separate task.

FIG. 10 shows an example of the data structure of the comment information database 23 according to this embodiment of the invention.

The comment information database 23 stores multiple instances of analytical results data. The analytical results data includes one or multiple conditions 68 comprising an index type 64 of the managerial index calculated from the financial data and a range 66 of values for the managerial index, and comment data 70 appropriate to the conditions 68.

The comment data 70 includes the text 72 of the analytical result comment and a value indicating the importance level 74. The text 72 includes structured text data 76, and an index variable 78 for embedding the values of desired managerial indices.

The analytical function 32 calculates the values of managerial indices from the financial data stored in the financial database, and extracts the analytical results data matching the managerial index values from the comment information database 23. The analytical function 32 embeds the managerial index values corresponding to the index variable 78 in the comment data 70 contained in the extracted analytical results data, and outputs to the web control function 28. The web control function 28 then displays the simple format versions of the text 72 of the comment data 70 in the analytical result candidate selection area 46 in the order of the values indicated by the importance level 74.

The comment information database 23 stores, for each analytical result comment, text data including the text strings of the structured text data appropriate to the analytical result comment, and the insertion fields to which are inserted the managerial index values corresponding to the text strings.

The analytical function 32 creates an analytical result comment by inserting the calculated managerial index values to the insertion fields of the text data corresponding to the analytical result comment.

As a result, a story describing a management improvement plan can be automatically constructed by the user selecting analytical result comments. In addition, stories can be created more efficiently than when stories are created freely.

Based on the content of the structured text data corresponding to the multiple calculated managerial index values, and the calculated managerial index values, the analytical function 32 generates analytical result comments corresponding to the business situation of the business targeted by the analysis.

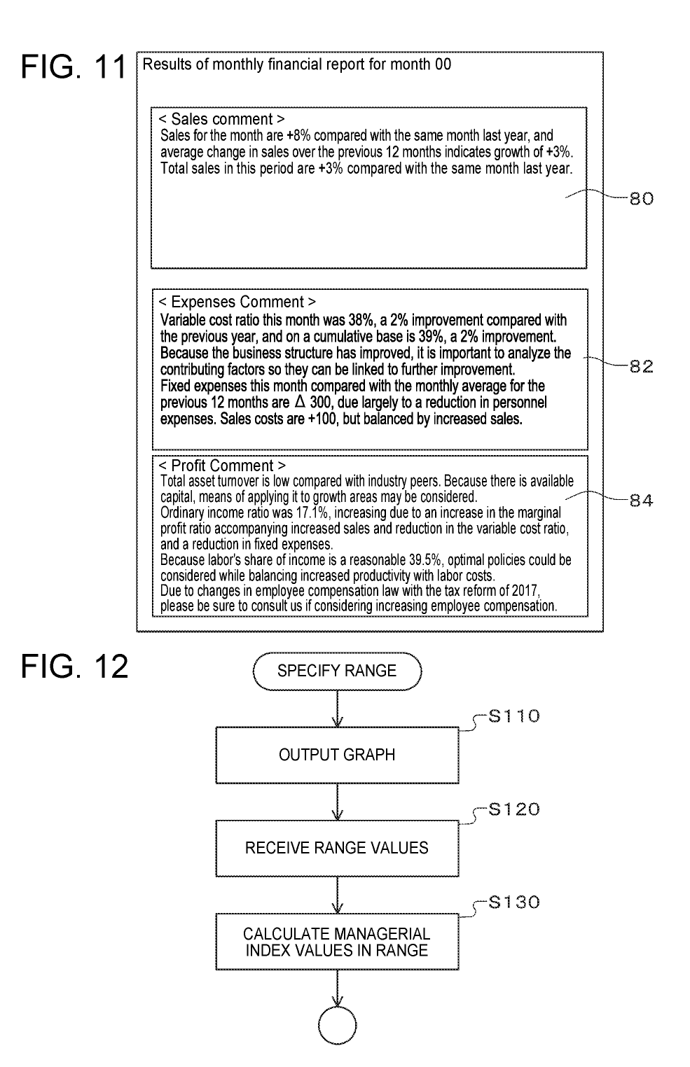

FIG. 11 shows an example of perspectives according to this embodiment and the corresponding analytical result comments. As examples of perspectives and analytical result comments, this example analyzes a monthly financial report for a company from the perspectives of sales, expenses, and profit.

As shown in pane 80 in FIG. 11, the text 72 for the Sales Comment of “Sales for the month are +8% compared with the same month last year, and average change in sales over the previous 12 months indicates growth of +3%.” includes the structured text data 76 “Sales for the month are _% compared with the same month last year, and average change in sales over the previous 12 months indicates growth of _%.”, and the values +8 and +3 substituted for the index variables 78 in the insert fields _.

In addition, the text 72 of “Total sales in this period are +3% compared with the same month last year.” Comprises the structured text data 76 “Total sales in this period are _% compared with the same month last year.” and the value +3 substituted for the index variable 78 in the insert field _.

As shown in pane 82 in FIG. 11, the text 72 for the Expenses Comment of “Variable cost ratio this month was 38%, a 2% improvement compared with the previous year, and on a cumulative base is 39%, a 2% improvement.” comprises the structured text data 76 “Variable cost ratio this month was is _%, a _% improvement compared with the previous year, and on a cumulative base is _%, a _% improvement.”, and the values 38, 2, 39, and 2 substituted for the index variables 78 in the insert fields _.

In addition, the text 72 of “Fixed expenses this month compared with the monthly average for the previous 12 months are Δ300, due largely to a reduction in personnel expenses. Sales costs are +100, but balanced by increased sales.” comprises the structured text data 76 “Fixed expenses this month compared with the monthly average for the previous 12 months are _, due largely to a reduction in personnel expenses. Sales costs are _, but balanced by increased sales.”, and the values Δ300 and +100 substituted for the index variables 78 in the insert fields _.

As shown in pane 84 in FIG. 11, the text 72 for the Profit Comment of “Ordinary income ratio was 17.1%, increasing due to an increase in the marginal profit ratio accompanying increased sales and reduction in the variable cost ratio, and a reduction in fixed expenses.”, comprises “Ordinary income ratio was _%, increasing due to an increase in the marginal profit ratio accompanying increased sales and reduction in the variable cost ratio, and a reduction in fixed expenses.”, and the value 17.1 substituted for the index variable 78 in the insert field _.

The text 72 “Because labor's share of income is a reasonable 39.5%, optimal policies could be considered while balancing increased productivity with labor costs.”, comprises “Because labor's share of income is a reasonable _%, optimal policies could be considered while balancing increased productivity with labor costs.”, and the value 39.5 substituted for the index variable 78 in the insert field _.

A program according to the invention causes a computer to execute a data acquisition function, a business analysis function, and an output function. The data acquisition function acquires financial data of the business to analyze. The program calculates managerial index values based on the business analysis function and the acquired financial data; and based on a comment information database 23 relating the managerial index values and analytical result comments, determines the analytical result comments appropriate to the calculated managerial index values. The output function then outputs the analytical result comments. The comment information database 23 stores multiple relations between managerial index values and analytical result comments, and when multiple analytical result comments corresponding to the calculated managerial index values are identified by the analysis of the business analysis function, the output function outputs the multiple analytical result comments.

Note that the program executed by the management support system 2 (management support server 10 and terminal 12) in the embodiment described above may be distributed stored on a computer-readable recording medium such as a floppy disk, CD-ROM (Compact Disc Read-Only Memory), DVD (Digital Versatile Disc), or MO (Magneto-Optical Disc), and the management support system 2 (management support server 10 and terminal 12) may be embodied by installing the program and running the program on a computer.

Furthermore, when the processes embodying the operation of the management support system 2 (management support server 10 and terminal 12) are executed by an operating system, or embodied by the cooperation of an operating system and an application, the part other than the portion executed by the operating system may be stored and distributed, or downloaded, from a recording medium.

This embodiment of the invention enables calculating managerial index values based on financial data, referencing a comment information database 23 of multiple relations between the managerial index values and analytical result comments, and outputting multiple analytical result comments. As a result, because multiple analytical result comments appropriate to the business situation of a specific business can be output, the user can easily acquire desired analytical result comments, and user convenience is excellent.

This embodiment of the invention provides multiple analytical result comments corresponding to the managerial indices of financial data for the user to select. As a result, because analytical result comments can be determined by a single selection, results can be acquired in a short time. In addition, because multiple analytical result comments can be viewed, there is less chance of the most valuable results being discarded.

### Variation 1

The analytical function 32 in the embodiment described above generates interpretive result data, but if the web control function 28 receives a range command from the user specifying a range of results to graph for the interpretive result data, the analytical function 32 may create the analytical result comments for the range of values specified by the range command. As a result, by selecting what to focus on in the graph, the corresponding analytical result comments can be known. Creating the interpretive result data can also be made more efficient. Furthermore, by using a display with touch panel functionality, data can be analyzed in real time to acquire the desired analytical result comments.

The analytical function 32, based on financial data and a range command, may also calculate managerial index values corresponding to the range specified by the range command, reference the comment information database 23, and determine the analytical result comments corresponding to the calculated managerial index values. Thus comprised, by selecting the points to focus on in the graph, the corresponding analytical result comments can be known by referencing a comment information database 23 storing multiple managerial index value and analytical result comment relations.

When a value range for a graph already displayed in the graph display area 60 shown in FIG. 9 is specified, the analytical result comments calculated from the financial data of the range selected in the analytical result candidate selection area 46 may be displayed in the analytical result candidate selection area 46. When analytical result comments are selected in the analytical result candidate selection area 46, a graph corresponding to those analytical result comments may be constructed, and the analytical result comments displayed in the area of the analytical results display area 44 corresponding to that graph. As a result, by selecting the points to focus on in the graph, the corresponding analytical result comment can be known. In addition, business analysis documents can be created more efficiently. Furthermore, by using a display with touch panel functionality, data can be analyzed in real time to acquire the desired analytical result comments.

The operation of a management support system 2 according to a variation of the foregoing embodiment is described next. FIG. 12 is a flow chart of the operation of the management support system 2 according to this embodiment. First, in step S110, the web control function 28 outputs a graph to the graph display area 60.

Next, in step S120, the web control function 28 receives a range of values specified by the user for the graph in the graph display area 60 to focus on.

Next, in step S130, the analytical function 32 recalculates the managerial index values in that range. The web control function 28 then outputs the multiple analytical result comments to the analytical result candidate selection area 46.

### Variation 2

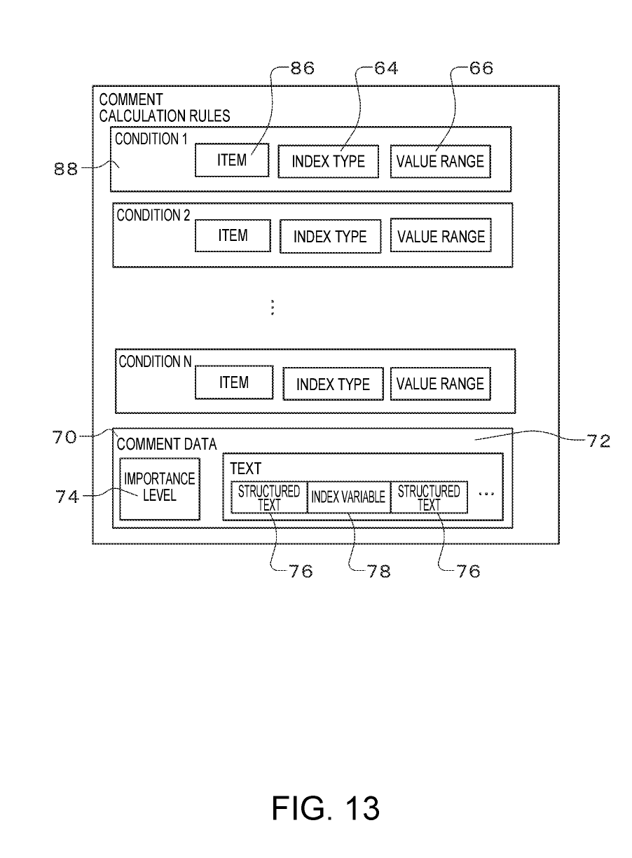

FIG. 13 shows the data structure of a comment information database 23 according to another embodiment. As shown in FIG. 13, the condition 88 for analytical results data may include a balance item 86 to focus on, the index type 64 of the managerial index corresponding to the balance item 86, and a range 66 of managerial index values. This configuration can generate analytical results data based on a condition 88 focusing on a specific item 86.

In addition, in subsequent business analyses of the financial data of the target business, analytical result comments may be displayed based on previously selected analytical result comments (without additional user input (selection)).

Furthermore, the management support server 10 in the foregoing embodiment is a management support device, but the terminal 12 (a personal computer on which a program of an application with the management support functionality described above) may be the management support device. Yet further, a configuration that functions as a management support device may be embodied by the cooperation of a personal computer on which the application program is installed, and a management support server 10.

The embodiment described above displays analytical results on the terminal 12, but the invention is not so limited to this display method, and may be configured to output a file containing the analytical results in a file format compatible with third-party spreadsheet software. Thus comprised, the user can download to a terminal 12 from the management support server 10 a file containing multiple analytical results, and use the spreadsheet program to add user-desired modifications to the analytical results in the received file. User convenience is there good. For example, if the user is a consultant providing advice related to business management, the user can open the file output from the management support device, add information and changes to the analytical results as desired, and provide more appropriate advice to the business.

The databases described above may also be stored on or separately from the management support device. The databases may be on the management support server 10 or the terminal 12.

The analytical function 32 may also calculate managerial index values related to the operations of a target business based directly on the financial data of a financial database instead of going through the analytical information database 22.

The invention may be embodied in many ways and forms without departing from the broad technical scope of the invention. The foregoing embodiments are for describing the invention, and do not limit the scope of the invention. More specifically, the scope of the invention is described not in the foregoing embodiments, but in the accompanying claims. Various modifications conceivable within the scope of the accompanying claims and the same scope as the intent of the invention are also included within the scope of the invention.

The entire disclosure of Japanese Patent Application No. 2017-125926, filed Jun. 28, 2017 is expressly incorporated by reference herein.

What is claimed is:

1. A management support device comprising:
a data acquisition device configured to acquire financial data;
a business analyzer configured to calculate a managerial index value based on the acquired financial data, and based on a database of multiple relations between managerial index values and analytical results, determines multiple analytical results corresponding to the calculated values of the managerial indices; and
an output device configured to output the multiple analytical results.

2. The management support device described in claim 1, further comprising:
an input device configured to receive input of a selection command;
the output device, when a selection command selecting an analytical result from among the multiple output analytical results is received from the input device, outputting the selected analytical result as the analytical result.

3. The management support device described in claim 2, wherein:
the output device outputs the multiple analytical results in a first format, and outputs the selected analytical result in a second format that is more detailed than the first format.

4. The management support device described in claim 1, wherein:
the business analyzer, based on the calculated managerial index value and the financial data, generates interpretive result data including the analytical result and a graph corresponding to the analytical result; and
the output device outputs the interpretive result data.

5. The management support device described in claim 4, wherein:
when the input device receives a range command specifying a focus range for a graph of the interpretive result data, the business analyzer determines the analytical result corresponding to the range specified by the range command.

6. The management support device described in claim 5, wherein:
the business analyzer, based on the financial data and the range command, calculates the managerial index values corresponding to the range specified by the range command, references the database, and determines the analytical result corresponding to the value of the corresponding managerial index.

7. The management support device described in claim 1, wherein:
the database stores, for each analytical result, text data including a structured string corresponding to the analytical result, and an insertion field to which the value of the managerial index corresponding to the text string is inserted; and
the business analyzer determines the analytical result by inserting the calculated value of the managerial index to the input field of the text data corresponding to the analytical result.

8. The management support device described in claim 1, wherein:
the business analyzer determines an importance level for each analytical result; and
the output device outputs multiple analytical results in an order based on the importance level.

9. The management support device described in claim 1, wherein:
the output device outputs the multiple determined analytical results as a file of a specific format.

10. A management support method of a management support device, comprising:
a data acquisition step of acquiring financial data;
a step of calculating a managerial index value based on the acquired financial data, and based on a database of multiple relations between managerial index values and analytical results, determines multiple analytical results corresponding to the calculated values of the managerial indices; and
outputting the multiple calculated analytical results.

11. A computer-readable recording medium storing a program causing a computer to execute:
a function of acquiring financial data;
a function of calculating a managerial index value based on the acquired financial data, and based on a database of multiple relations between managerial index values and analytical results, determining multiple analytical results corresponding to the calculated values of the managerial indices; and
a function of outputting the multiple analytical results.
